(19) United States
(12) Patent Application Publication
(10) Pub. No.: US 2012/0206568 A1
(43) Pub. Date: Aug. 16, 2012

(54) COMPUTING DEVICE HAVING MULTIPLE IMAGE CAPTURE DEVICES AND IMAGE MODES

(75) Inventor: Amy Han, Palo Alto, CA (US)

(73) Assignee: GOOGLE INC., Mountain View, CA (US)

(21) Appl. No.: 13/024,802

(22) Filed: Feb. 10, 2011

(51) Int. Cl. H04N 13/02; H04N 13/00

(52) U.S. Cl. 348/43; 348/48; 348/E13.021; 348/E13.074

(57) ABSTRACT

A computer-readable storage medium can be configured to store code to trigger, when a computing device is in a stereoscopic mode, generation of a stereoscopic image based on a first image captured using a first image capture device in a first portion of a computing device and based on a second image captured using a second image capture device in a second portion of the computing device. The code including code to trigger, when in a multi-image mode, concurrent display of at least a portion of a third image captured using the first image capture device in a first region of a display and at least a portion of a fourth image captured using the second image capture device in a second region of the display mutually exclusive from the first region of the display. The code including code to receive an indicator configured to trigger the computing device to change between the stereoscopic mode and the multi-image mode.

### TECHNICAL FIELD

This description relates to image capture devices integrated into a computing device.

### BACKGROUND

Many known computing devices have a mechanism through which a user may capture images for one or more applications of the computing device. For example, image capture devices, which can have a lens, a sensor, and/or so forth, can be incorporated into a computing device to capture one or more images that can be stored at the computing device and/or transmitted using a video conferencing application. However, these image capture devices may be cumbersome to use and/or may not produce results at a desirable speed, level of accuracy, and/or with a desired effect.

### SUMMARY

In one general aspect, a computer-readable storage medium can be configured to store code to trigger, when a computing device is in a stereoscopic mode, generation of a stereoscopic image based on a first image captured using a first image capture device in a first portion of a computing device and based on a second image captured using a second image capture device in a second portion of the computing device. The code including code to trigger, when in a multi-image mode, concurrent display of at least a portion of a third image captured using the first image capture device in a first region of a display and at least a portion of a fourth image captured using the second image capture device in a second region of the display mutually exclusive from the first region of the display. The code including code to receive an indicator configured to trigger the computing device to change between the stereoscopic mode and the multi-image mode.

In another general aspect, a computing device can include a display, and a first image capture device included in a first portion of the computing device and configured to capture a first plurality of images. The computing device can also include a second image capture device included in a second portion of the computing device and configured to capture a second plurality of images, and an image processor configured to generate at least a portion of a stereoscopic image based on a first portion of the first plurality of images and on a first portion of the second plurality of images. The image processor can be configured to trigger display of a second portion of the first plurality of images in a first region of the display and a second portion of the second plurality of images in a second region of the display mutually exclusive from the first region of the display.

In yet another general aspect, a method can include capturing a first image of an object using a first image capture device in a first portion of a computing device, and capturing a second image of the object captured using a second image capture device in a second portion of the computing device. The method can also include generating a stereoscopic image based on a combination of the first image and the second image. The method can include triggering, when the computing device is in a multi-image mode, concurrent display of a third image captured using the first image capture device in a first region of a display and a fourth image captured using the second image capture device in a second region of the display mutually exclusive from the first region of the display. The method can also include changing between the stereoscopic mode and the multi-image mode.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates a computing device that has multiple image capture devices.

FIG. 1B is a schematic diagram that illustrates a stereoscopic image displayed on the display shown in FIG. 1A.

FIG. 1C is a schematic diagram that illustrates multiple images displayed on the display shown in FIG. 1A.

FIG. 1D is a block diagram view of the computing device shown in FIG. 1A.

FIG. 2A is diagram that illustrates a computing device in a stereoscopic mode.

FIG. 2B is diagram that illustrates the computing device shown in FIG. 2A in a multi-image mode.

FIG. 3 is diagram that illustrates a computing device in a multi-image mode.

FIG. 4 is a block diagram that illustrates a computing device that includes multiple image capture devices.

FIG. 5 is a flowchart that illustrates a method for changing image modes of a computing device.

### DETAILED DESCRIPTION

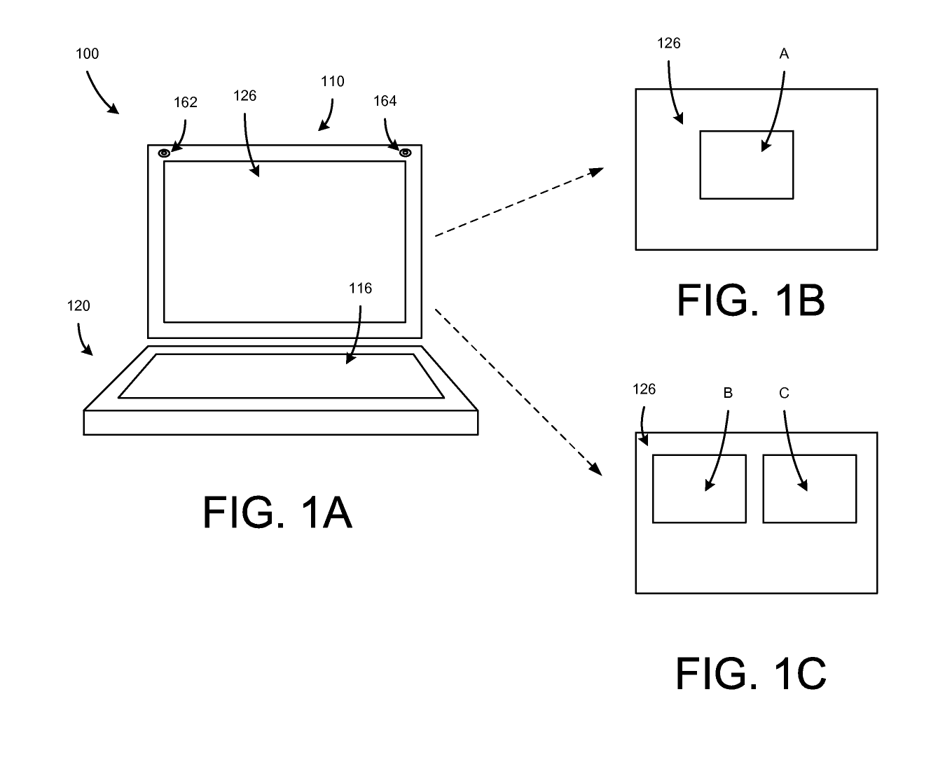

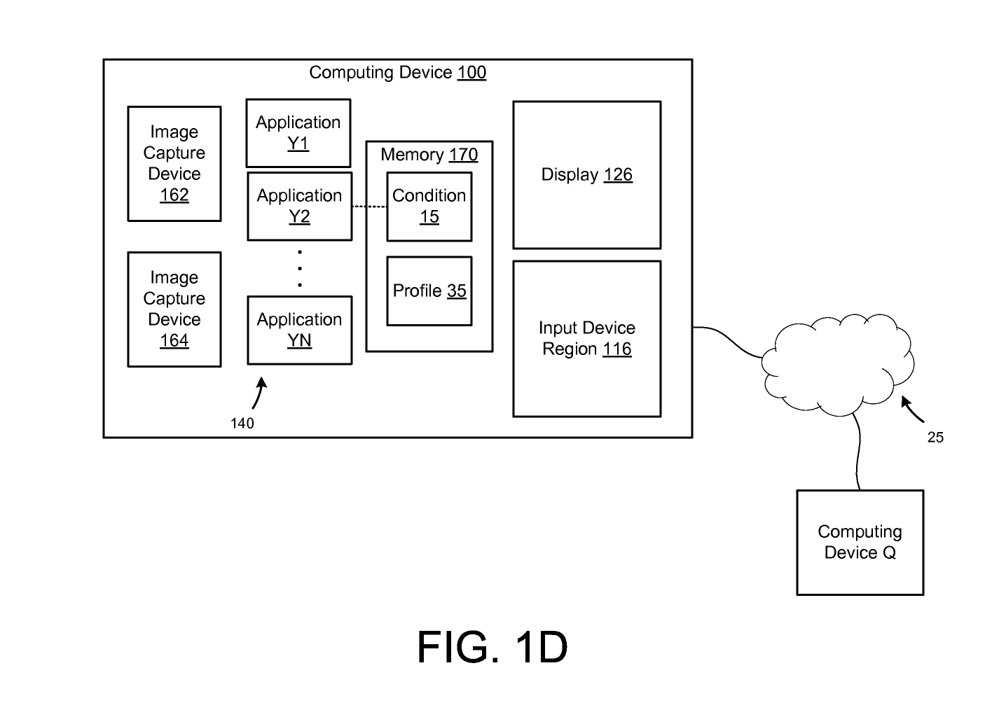

FIG. 1A is a diagram that illustrates a computing device 100 that has multiple image capture devices. Specifically, the computing device 100 has an image capture device 162 and an image capture device 164. The computing device 100 is configured to change between image modes (also can be referred to as image capture modes or as image display modes). The image modes can include, for example, the stereoscopic mode, a multi-image mode, a single-image mode, high dynamic range (HDR) mode, and/or so forth. Image modes different from the stereoscopic mode can be referred to as non-stereoscopic modes. For example, the computing device 100 can be configured to change between a stereoscopic mode to a multi-image mode or to a single-image mode. The computing device 100 can be referred to as operating in a particular image mode when at least a portion of the computing device 100 (such as an application and/or image capture device associated with the computing device 100) is operating in the particular image mode. When in a particular image mode, the computing device 100 can be configured to capture (and subsequently display) an image or a series/set of images (e.g., a video) using the image capture devices 162, 164 in a fashion consistent with the particular image mode.

As a specific example, the computing device 100 can be used by a first user to produce, at the computing device 100, a stereoscopic image of, for example, the first user during a video conference session while the computing device 100 is in the stereoscopic mode. In some instances, the stereoscopic image can be displayed locally and/or sent to a remote computing device (for display at the remote computing device (e.g., a destination computing device)) communicating via the video conference session. If a second user joins the video conferencing session in the same room as the first user, the computing device 100 can be changed from the stereoscopic mode to the multi-image mode so that separate images of the first user and the second user can be used (e.g., displayed locally, sent to the remote computing device for display at the remote computing device) during the video conferencing session. If the remote computer is not configured to process (e.g., handle) stereoscopic images related to the stereoscopic mode and/or multiple images related to the multi-image mode during the video conference session, the computing device 100 can be changed to a single-image mode where only one image is captured and used during the video conference session. In some embodiments, the capabilities of the remote computing device (with respect to one or more image modes) can be sent to the computing device 100 in a signal (e.g., a feedback signal) from the remote computing device during start-up of the video conference session.

As shown in FIG. 1A, the computing device 100 has a base portion 120 and a display portion 110. The base portion 120 can include an input device region 116. The input device region 116 can include various types of input devices such as, for example, a keyboard, one or more buttons, an electrostatic touchpad to control a mouse cursor, etc. The display portion 110 can include a display 126. The display 126 can have a display surface (also can be referred to as a viewable surface) upon which illuminated objects can be displayed and viewed by a user.

When in the stereoscopic mode, the computing device 100 is configured to produce at least one three-dimensional (3D) image using images captured by both the image capture device 162 and the image capture device 164. For example, the computing device 100, when in the stereoscopic mode, can be configured to produce and trigger display of a single three-dimensional image from a first image captured by the image capture device 162 and a second image captured by the image capture device 164.

FIG. 1B is a schematic diagram that illustrates a stereoscopic image A displayed on the display 126 shown in FIG. 1A. The stereoscopic image A can be displayed on the display 126 when the computing device 100 is in a stereoscopic mode. The stereoscopic image A can be produced based on at least a portion of an image captured by the image capture device 162 and based on at least a portion of an image captured by the image capture device 164. Thus, the stereoscopic image A can be produced based on portions of images captured by each of the image capture device 162 and the image capture device 164. In some embodiments, the stereoscopic image A may only be viewed by a user using, for example, specialized glasses for viewing the stereoscopic image A.

When in the multi-image mode, the computing device 100 is configured to produce multiple mutually exclusive images captured by the image capture devices 162, 164. For example, the computing device 100, when in the multi-image mode, can be configured to trigger display (e.g., trigger display locally or at another computing device) of a first image captured by the image capture device 162 and trigger display (e.g., trigger display locally or at another computing device) of a second image captured by the image capture device 164. In some embodiments, the first image can be of a first object (e.g., first person) mutually exclusive from a second object (e.g., a second person) that is the subject of the second image. As another example, the computing device 100, when in the multi-image mode, can be configured to send (e.g., send via a network) a first image (or a portion thereof) captured by the image capture device 162 (for display at another computing device) and send (e.g., send via the network) a second image (or a portion thereof) captured by the image capture device 164 (for display at the other computing device). The first image and the second image can be sent as separate images (e.g., discrete images, independent images) that are not combined into a stereoscopic image before being sent. In some embodiments, the first image and/or the second image can include, or can be associated with, one or more indicators (e.g., flags, fields) configured to trigger separate display at a remote computing device (not shown in FIG. 1B).

FIG. 1C is a schematic diagram that illustrates multiple images displayed on the display 126 shown in FIG. 1A. The multiple images can be displayed on the display 126 when the computing device 100 is in a multi-image mode. Specifically, image B can be produced based on at least a portion of an image captured by the image capture device 162, and image C can be produced based on at least a portion of an image captured by the image capture device 164. As shown in FIG. 1C, the image B and the image C are displayed in mutually exclusive regions of the display 126. In some embodiments, the image B and the image C can be displayed in an overlapping fashion so that each of images B and C are not in mutually exclusive regions of the display 126 (but are not combined into a stereoscopic image). When the computing device 100 is in the multi-image mode or in the stereoscopic mode, both image capture device 162 and image capture device 164 can be active (e.g., in an active state, in an on state, in an active mode).

Although not shown in FIGS. 1A through 1C, in some embodiments, the computing device 100 can be configured to display a single image that is not a stereoscopic image when the computing device 100 is in a single-image mode. In such embodiments, the computing device 100 can be configured to display a single image produced by only one of the image capture devices. For example, the computing device 100, when in the single image mode, can be configured to display a single image (or set of images) captured by the image capture device 162. Because the single image (or set of images) is captured by the image capture device 162, the image capture device 164 can be inactive (e.g., in an inactive state, in an off state, in a sleep state). In some embodiments, when in the single-image mode, images produced by the computing device 100 can be high dynamic range images. More details related to a high dynamic range image mode are discussed below.

In some embodiments, the images captured by the image capture devices 162, 164 (as discussed herein) can be single, static images (such as a photograph) or can be images from a series (or set) of images defining a video (e.g., a progressive scan video, a National Television System Committee (NTSC) video, a Motion Picture Experts Group (MPEG) video). In some embodiments, the series of images (which can define (e.g., generate) the video) can be synchronized with, or otherwise associated with, audio (e.g., an audio signal). For example, when the computing device 100 is in the stereoscopic mode, a first image captured by the image capture device 162 can be from a first series of images and a second image captured by the image capture device 164 can be from a second series of images. A stereoscopic image produced based on the first image and the second image can be included in a series of stereoscopic images (which can define a video sequence) produced based on the first series of images and the second series of images.

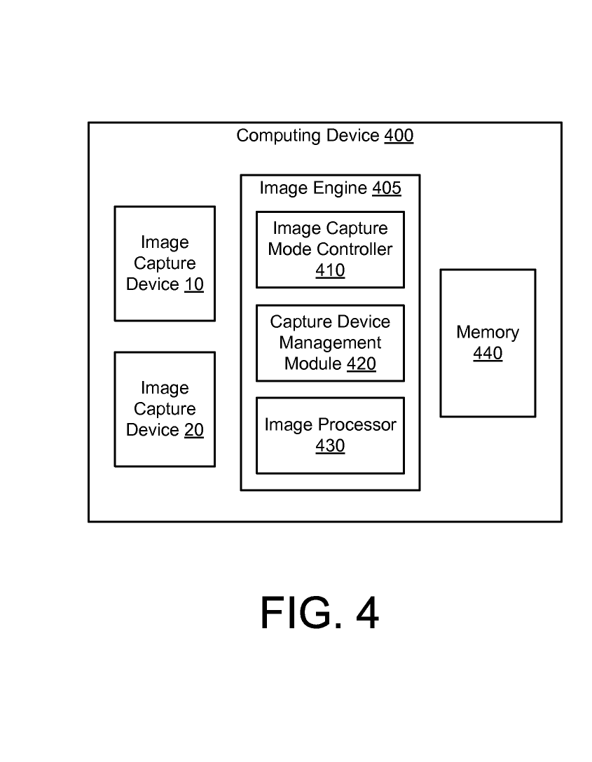

FIG. 1D is a block diagram view of the computing device 100 shown in FIG. 1A. The block diagram view of the computing device 100 illustrates the input device region 116, the display 126, the image capture devices 162, 164, applications 140, and a memory 170. The applications 140 (which include applications Y1 through YN) can be applications installed at and/or operating at the computing device 100. In some embodiments, one or more of the applications 140 can be configured to interface with the image capture devices 162, 164, the display 126, the memory 170, and/or the input device region 116. In some embodiments, the applications 140 can be configured to interface with the image capture devices 162, 164, the display 126, the memory 170, and/or the input device region 116 via an image engine (not shown) that can be separate from (e.g., operate independent of) one or more of the applications 140 and/or can be incorporated into one or more of the applications 140. More details related to an image engine are discussed in connection with FIG. 4. Also, as shown in FIG. 1D, the computing device 100 can be configured to communicate with computing device Q via a network 25.

In some embodiments, the computing device 100 can be configured to change between image modes in response to an indicator. In some embodiments, the indicator can be produced by one or more of the applications 140 (e.g., a video conferencing application, a video production application, a chat application, a photo editing application) operating at the computing device 100. In some embodiments, the computing device 100 can be configured to change between image modes in response to an indicator triggered via an interaction of the user with the computing device 100. For example, the computing device 100 can be configured to change between image modes in response to an indicator triggered by a user via a user interface and/or input device within the input device region 116 of the computing device 100.

In some embodiments, the computing device 100 can be configured to change between image modes in response to a condition 15 being satisfied based on an indicator. In this embodiment, the condition 15 is stored in the memory 170 (e.g., a disk drive, a solid-state drive), and is associated with application Y2. For example, the computing device 100 can be configured to change from a stereoscopic mode to a multi-image mode in response to the condition 15 being satisfied based on an indicator triggered via, for example, a user interface. In some embodiments, the condition 15 can be configured to trigger (e.g., when satisfied or unsatisfied) the computing device 100 to change between image modes can be referred to as an image condition. Although not shown, any of the applications 140 can be associated with one or more conditions (e.g., image conditions) similar to the condition 15.

In some embodiments, one or more of the image modes of the computing device 100 can be associated with one or more of the applications 140 operating at the computing device 100. In some embodiments, the application(s) 140 installed at and/or operating at the computing device 100 can be configured to control the image capture devices 162, 164 so that the computing device 100 is changed between one or more of the image modes. For example, application Y1 can be associated with a stereoscopic mode of the computing device 100 and may be used to define (e.g., generate) one or more stereoscopic images using the image capture devices 162, 164. In such instances, the computing device 100 can be referred to as operating in the stereoscopic mode based on the application Y1. In some embodiments, the application Y1 can be a third-party application installed on the computing device 100, or can be an application that natively operates at the computing device 100 (such as an operating system and/or kernel of the computing device 100).

In some embodiments, one or more of the applications 140 can be used to change the computing device 100 from one image mode to another image mode. In some embodiments, the application(s) 140 can be configured to produce an indicator that triggers a change (by the applications 140 or another mechanism such as an image engine) between image modes of the computing device 100. For example, in some embodiments, the application(s) 140 can be configured to trigger the computing device 100 to produce a stereoscopic image based on images captured by the image capture devices 162, 164. The application(s) 140 can also be configured to trigger the computing device 100 to produce multiple images in a multi-image mode based on images captured by the image capture devices 162, 164. Thus, the application(s) 140 can be used to trigger the computing device 100 to change from, for example, a stereoscopic mode to a multi-image mode. In some embodiments, the application(s) 140 can be configured to trigger the computing device 100 to change between image modes in response to an interaction of the user with the application(s) 140 via a user interface (e.g., a user interface associated with the input device region 116).

In some embodiments, the computing device 100 can be configured to change between image modes in response to one or more of the applications 140 being activated (e.g., opened) and/or deactivated (e.g., closed). For example, in some embodiments, application YN can be associated with, for example, a stereoscopic mode of the computing device 100. The computing device 100 can be configured to change to the stereoscopic mode in response to the application YN being activated. As another example, application YN may be compatible with a stereoscopic mode of the computing device 100, and may not be compatible with a multi-image mode of the computing device 100. When the application YN is activated, the computing device 100 may be triggered by the application YN to change from the multi-image mode to the stereoscopic mode. Thus, the computing device 100 can be configured to change between image modes (and/or control of the computing device 100 when in a particular image mode can be changed) based on the capabilities of the application(s) 140 operating within the computing device 100.

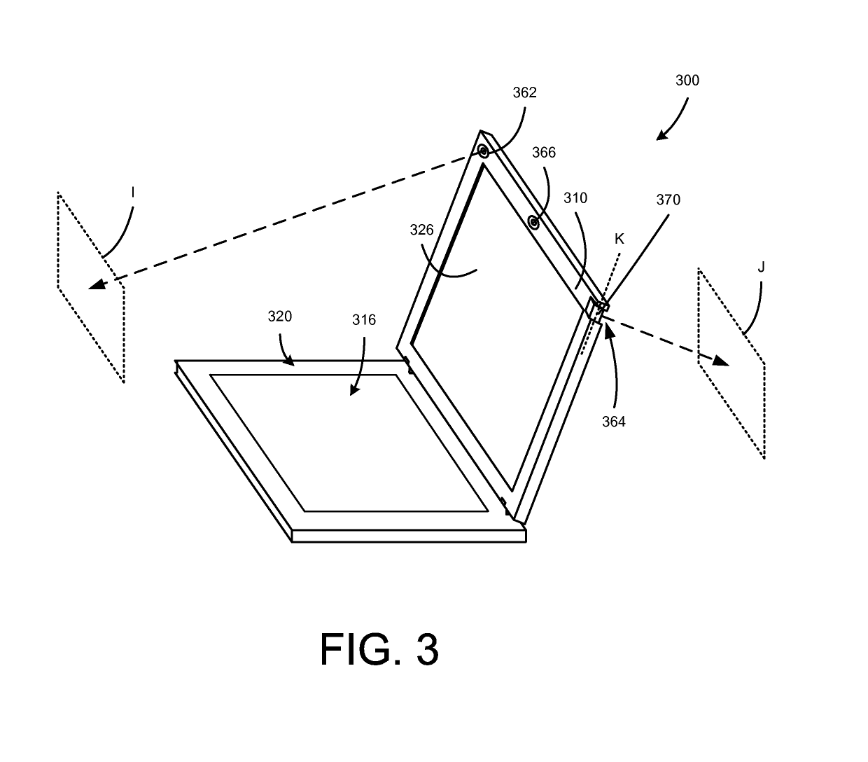

Although not shown in FIGS. 1A through 1C, in some embodiments, the computing device 100 can be configured to change between image modes in response to one or more of the image capture devices being physically manipulated. An example of a computing device 100 that is configured to change between image modes in response to an image capture device being physically manipulated is described in connection with FIG. 3.

In some embodiments, the computing device 100 (and/or one or more of the applications 140 thereof) can be configured to change between image modes in response to failure of at least one of the image capture devices 162, 164. For example, the computing device 100 (and/or one or more of the applications 140 thereof) can be configured to produce stereoscopic image (when in the stereoscopic mode) based on images captured by the image capture devices 162, 164. The computing device 100 can be configured to change from the stereoscopic mode to a single-image mode in response to failure of the image capture device 162.

In some embodiments, the computing device 100 (or portions thereof) can be configured to change between image modes based on a profile 35 (e.g., an image profile). As shown in FIG. 1D, the profile 35 is stored in the memory 170. In some embodiments, the computing device 100 can be configured to produce (e.g., produce using one or more of the applications 140 operating at the computing device 100), for example, stereoscopic images in a stereoscopic mode based on the profile 35. In some embodiments, the profile 35 can be associated with a user and stored at the computing device 100. In some embodiments, the computing device 100 can be configured to produce, for example, stereoscopic images in a stereoscopic mode based on a default profile associated with the computing device 100.

In some embodiments, the computing device 100 can be configured to change image modes in response to a signal received from another computing device. For example, the computing device 100 can be configured to operate (e.g., execute) a videoconference application (which can be one of the applications 140). In response to a signal (e.g., a feedback signal) from a remote computing device such as computing device Q in communication with the computing device 100 via the videoconference application, the computing device 100 can be configured to change from a single-image mode or from a multi-image mode to a stereoscopic mode so that the computing device 100 can send one or more stereoscopic images to the computing device Q. In such embodiments, the change in image mode of the computing device 100 may be triggered by (or via) the videoconference application. In some embodiments, the computing device Q can be in communication with the computing device 100 via the network 25 (e.g., the Internet, a wide area network (WAN), a local area network (LAN)).

As another example, in some embodiments, in response to a signal from a the computing device Q in communication with the computing device 100 via a videoconference application, the computing device 100 can be configured to change from a stereoscopic mode to a single-image mode. In such embodiments, the change in mode of the computing device 100 may be triggered using the signal from the computing device Q because the computing device Q may not be configured to process stereoscopic images from the computing device 100 when the computing device 100 is in the stereoscopic mode. In such embodiments, the change in mode of the computing device 100 may be triggered by (or via) the videoconference application through the 25 network.

In some embodiments, the computing device 100 can be configured to operate in multiple image modes during overlapping time periods (e.g., concurrently, at the same time). Thus, the image modes can occur concurrently at the computing device 100. For example, the image capture device 162 can be configured to capture images at a rate that is twice the capture rate of the image capture device 164. Even-numbered images captured by the image capture device 162 and all of the images captured by the image capture device 164 can be used to define (e.g., generate) stereoscopic images in a stereoscopic mode. Odd-numbered images captured by the image capture device 162 can be displayed in a separate region of the display 126 in a multi-image mode.

In some embodiments, portions of images captured by the image capture devices 162, 164 can be used by the computing device 100 in one or more of the image modes described above. In some embodiments, the image modes can occur concurrently. For example, a first portion of an image captured by the image capture device 162 and a first portion of an image captured by the image capture device 164 can be combined into a stereoscopic image that can be displayed (e.g., rendered) on the display 126. A second portion of the image captured by the image capture device 162 and a second portion of the image captured by the image capture device 164 can each be displayed in separate regions of the display 126 (in a multi-image mode fashion). In some embodiments, the stereoscopic image can be displayed in a region separate from the second portion of the image captured by the image capture device 162 and separate from the second portion of the image captured by the image capture device 164. In some embodiments, the field of view of the image capture device 162 and the field of view of the image capture device 164 can, or can be approximately the same, so that stereoscopic images and separate multi-mode images (e.g., mutually exclusive images) may be produced using images captured by the image capture devices 162, 164.

In some embodiments, the image modes of the computing device 100, which may or may not be occurring concurrently, can be associated with different applications from the applications 140. For example, application Y1 (which can be a video conferencing application) associated with the stereoscopic image mode of the computing device 100 can be configured to trigger the image capture devices 162, 164 to produce a stereoscopic image. Application Y2, which is separate from the application Y1, can be associated with a single image mode of the computing device 100 and can be configured to trigger another image capture device (not shown) to produce a single image displayed in a region of the display 126 separate from a region where the stereoscopic image is displayed within the display 126.

In some embodiments, the computing device 100 can be configured to have image modes different than those described above. For example, in some embodiments, the computing device 100 can be configured to produce high dynamic range (HDR) images (while in a high dynamic range image mode) using images captured by one or more of the image capture devices 162, 164. In some embodiments, the computing device 100 can be configured to change between the high dynamic range image mode and any of the image modes described above.

In some embodiments, the display 126 included in the display portion 110 can be, for example, a touch sensitive display. In some embodiments, the display 126 can be, or can include, for example, an electrostatic touch device, a resistive touchscreen device, a surface acoustic wave (SAW) device, a capacitive touchscreen device, a pressure sensitive device, a surface capacitive device, a projected capacitive touch (PCT) device, and/or so forth. If a touch sensitive device, the display 126 can function as an input device. For example, the display 126 can be configured to display a virtual keyboard (e.g., emulate a keyboard) that can be used by a user as an input device.

Although not shown, in some embodiments, the base portion 120 can include various computing components such as one or more processors, a graphics processor, a motherboard, and/or so forth. One or more images displayed on a display of the display portion 110 can be triggered by the computing components included in the base portion 120.

Referring back to FIG. 1A, the computing device 100 is a traditional laptop-type device with a traditional laptop-type form factor. In some embodiments, the computing device 100 can be, for example, a wired device and/or a wireless device (e.g., wi-fi enabled device) and can be, for example, a computing entity (e.g., a personal computing device), a server device (e.g., a web server), a mobile phone, a personal digital assistant (PDA), a tablet device, e-reader, and/or so forth. The computing device 100 can be configured to operate based on one or more platforms (e.g., one or more similar or different platforms) that can include one or more types of hardware, software, firmware, operating systems, runtime libraries, and/or so forth. More details related to various configurations of a computing device that has a display portion configured to move with respect to a base portion are described in connection with the figures below.

As shown in FIG. 1A, the image capture device 162 is located at an upper left portion of the display portion 110 and the image capture device 164 is disposed at an upper right portion of the display portion 110. In some embodiments, one or more of the image capture devices 162, 164 can be coupled to different portions of the computing device 100. For example, an image capture device can be coupled to the base portion 120 of the computing device 100. In some embodiments, the computing device 100 can have more image capture devices than shown in FIG. 1A (i.e., more than two image capture devices). In such embodiments, a subset of the image capture devices can be used to produce a stereoscopic image. Also, subset of the image capture devices can be used when the computing device 100 is in a multi-image mode.

In some embodiments, the image capture devices 162, 164 can have one or more lenses, focusing mechanisms, image sensors (e.g., charge-coupled devices (CCDs)), and/or so forth. In some embodiments, image capture devices 162, 164 can include, and/or can be associated with, a processor, firmware, memory, software, and/or so forth.

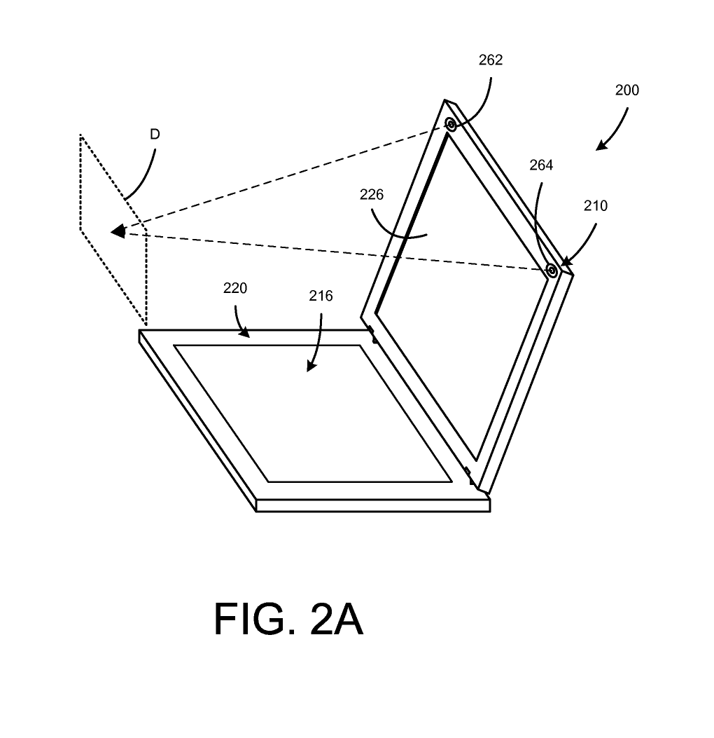

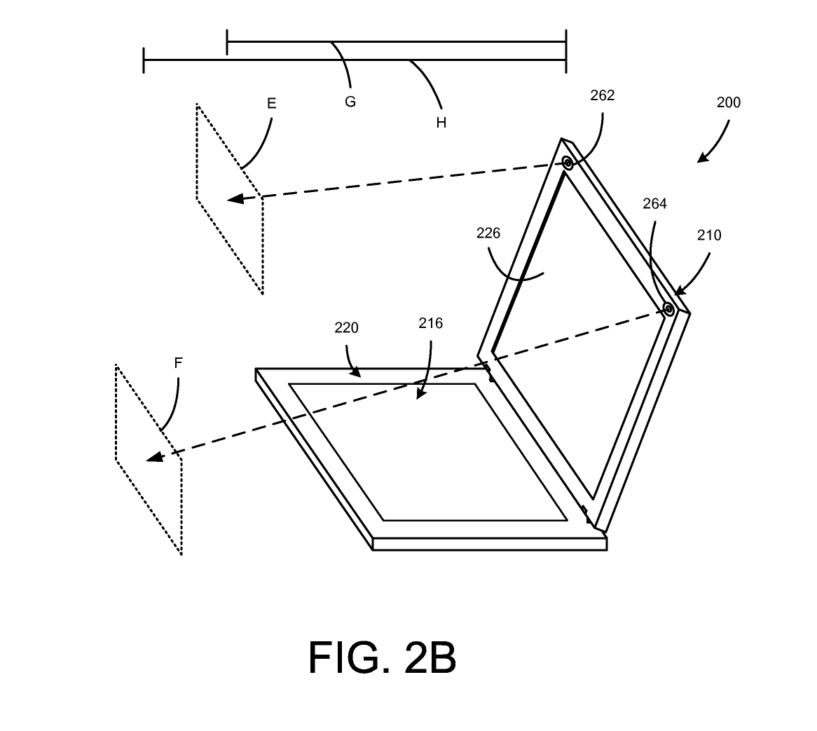

FIG. 2A is diagram that illustrates a computing device 200 in a stereoscopic mode. As shown in FIG. 2A, the computing device 200 has a display portion 210 that includes a display 226. The computing device 200 also has a base portion 220 that includes an input device region 216. The display portion 210 includes an image capture device 262 and an image capture device 264.

As shown in FIG. 2A, image capture devices 262, 264 are configured to capture images for a stereoscopic image as illustrated by the image capture devices 262, 264 being directed to (as represented by dashed arrows) a single focal plane D. In some embodiments, the single focal plane D can be associated with an object and can be approximately associated with a depth of focus of image capture devices 262, 264. Thus, a stereoscopic image of the object can be produced using the image capture device 262, 264 when the computing device 200 is in a stereoscopic mode. In this embodiment, the image capture device 262 is oriented on one side of the focal plane D and image capture device 264 is oriented on another side of the focal plane D so that a stereoscopic image of an object associated with the focal plane D may be produced by the computing device 200.

FIG. 2B is diagram that illustrates the computing device 200 shown in FIG. 2A in a multi-image mode. The computing device 200 can be configured to change between the stereoscopic mode shown in FIG. 2A and the multi-image mode shown in FIG. 2B.

As shown in FIG. 2B, when the computing device 200 is in the multi-image mode, image capture device 262 and image capture device 264 are each directed to different focal planes. Specifically, image capture device 262 is directed to (as represented by a dashed arrow) focal plane E, and image capture device 264 is directed to (as represented by a dashed arrow) focal plane F. As shown in FIG. 2B, the focal plane E and the focal plane F are separate in space from one another. Also, as shown in FIG. 2B, the focal plane E is approximately a distance G from the display portion 210, which is different from a distance H that represents the distance between the focal plane F and the display portion 210. Each of the focal planes E and F can be associated with different objects, or associated with different portions of the same object. Thus, separate images of the objects can be produced using the image capture devices 262, 264 when the computing device 200 is in the multi-image mode.

As illustrated by FIGS. 2A and 2B, when changing between the stereoscopic mode shown in FIG. 2A and the multi-image mode shown in FIG. 2B, the image capture devices 262, 264 of the computing device 200 can be directed to different focal planes. Specifically, when the computing device 200 is in the stereoscopic mode shown in FIG. 2A, image capture devices 262, 264 can be directed to a common focal plane (or common object or portion of a common object) and when the computing device 200 is in the multi-image mode shown in FIG. 2B, image capture devices 206 2, 264 can be directed to separate focal planes (or different objects or different portions of a single object).

In some embodiments, the image capture devices 262, 264 can be configured with one or more mechanical mechanisms (e.g., focusing mechanisms, zoom mechanisms, rotating mechanisms to turn the image capture devices 262, 264) that enable the image capture devices 262, 264 to be directed to different focal planes when the computing device 200 changes between the stereoscopic mode and the multi-image mode. For example, the image capture device 262 (or a portion thereof) and/or the image capture device 264 (or a portion thereof) can be configured to move (e.g., rotate) within the display portion 210 using a motor, a gear mechanism, a pulley system, and/or so forth.

In some embodiments, the image capture devices 262, 264 can be configured so that changes of the computing device 200 between image modes such as the stereoscopic mode shown in FIG. 2A and the multi-image mode shown in FIG. 2B can be electronically implemented. For example, in some embodiments, each of the image capture devices 262, 264 can have a relatively wide-angle lens and a relatively large depth of focus so that images at (or substantially out) the focal planes D, E, and/or F may be captured by both of the image capture devices 262, 264. Accordingly, when the computing device 200 is in the stereoscopic mode, portions of images captured by the image capture devices 262, 264 and that intersect at focal plane D can be used to produce a stereoscopic image. Similarly, a portion of an image captured by the image capture device 262 that intersects with focal plane E and a portion of an image captured by the image capture device 264 that intersects with focal plane F can be used (e.g., used as separate images) when the computing device 200 is in multi-image mode.

In some embodiments, one or more of the image capture devices 262, 264 can be configured to be (e.g., trained to be) directed towards one or more focal planes when associated with a particular image mode. For example, the image capture device 262 can be configured to automatically be directed to the focal plane E when the computing device 200 is changed to the multi-image mode shown in FIG. 2B (e.g., changed to the multi-image mode in response to an indicator from an application operating at the computing device 200). The image capture device 262 can be configured to automatically be directed to the focal plane D when the computing device 200 is changed to the stereoscopic mode shown in FIG. 2A (e.g., changed to the stereoscopic mode in response to an indicator from an application operating at the computing device 200). In some embodiments, the image capture device 262 can be configured to focus on the focal plane E (which can be associated with a first object) independent of focusing of the image capture device 264 on the focal plane F (which can be associated with the second object).

In some embodiments, the focal planes D, E, and F can represent a field of view of one or more of the image capture devices 262, 264. In some embodiments, the focal planes D, E, and F can represent a general direction of a field of view of one or more of the image capture devices 262, 264. In some embodiments, a field of view of the image capture device 262 can overlap with a field of view of the image capture device 264.

FIG. 3 is diagram that illustrates a computing device 300 in a multi-image mode. As shown in FIG. 3, the computing device 300 has a display portion 310 that includes a display 326. The computing device 300 also has a base portion 320 that includes an input device region 316. The display portion 310 includes multiple image capture devices. Specifically, the display portion 310 includes an image capture device 362, an image capture device 364 (not shown), and an image capture device 366.

As shown in FIG. 3, the image capture device 364 is coupled to a movement mechanism 370 configured to move with respect to the display portion 310. The movement mechanism 370 is configured to rotate about an axis K so that the image capture device 364 may be rotated. In the example shown in FIG. 3, the movement mechanism 370 is rotated so that the image capture device 364 is directed to focal plane J. The focal plane J is on an opposite side of the display portion 310 than focal plane I. In some embodiments, the focal plane J can be referred to as being distal to the display portion 310 (or display 326), and the focal plane I can be referred to as being proximal to the display portion 310 (or display 326).

In this embodiment, image capture device 362 is not coupled to a movement mechanism and is directed to focal plane I. Image capture device 366 is also not coupled to a movement mechanism, and image capture device 366 is in an inactive state.

In some embodiments, the computing device 300 can be changed between image modes in response to the image capture device 364 being rotated using the movement mechanism 370. For example, in some embodiments, the computing device 300 can be changed from the stereoscopic mode where image capture device 362 and the image capture device 364 or directed to a common focal plane to the multi-image mode shown in FIG. 3 when the image capture device 364 is rotated using the movement mechanism 370.

In some embodiments, the position of movement mechanism 370 with respect to the display portion 310 of the computing device 300 can be determined based on one or more indicators (e.g., signals) from, for example, a series of electrical contacts, mechanical switches, etc. In response to the indicator(s) the computing device 300 can be configured to change image mode. In some embodiments, a rotational position of movement mechanism 370 of the computing device 300 with respect to the display portion 310 of the computing device 300 can be determined based on signals from, for example, a series of electrical contacts, mechanical switches, etc. around movement mechanism 370 coupled to the display portion 310 of the computing device 300. In some embodiments, movement to a specified point (e.g., a specified rotational position with respect to the display portion 310 of the computing device 300), beyond a point, and/or so forth, can be detected using a mechanical switch that can be actuated, an electrical contact, and/or so forth.

In some embodiments, the movement mechanism 370 can be a movement mechanism configured to move (e.g., rotate) using a motor, a gear mechanism, a spring-loaded mechanism, and/or so forth. In some embodiments, the movement mechanism 370 can be configured to be manually moved by a user of the computing device 300.

In some embodiments, the computing device 300 may be configured so that the movement mechanism 370 may optionally be prevented from moving (e.g., rotating) beyond a specified point. For example, a locking mechanism can be activated (e.g., actuated) so that the movement mechanism 370 may not be rotated about the axis K beyond a specified position. In some embodiments, the locking mechanism may later be deactivated so that the movement mechanism 370 may be rotated about the axis K beyond a specified position.

In some embodiments, the image capture device 364 can be configured to capture, during a first period of time, a first set of images that can be used to produce at least a portion of a stereoscopic set of images when the image capture device 364 is in a position facing towards focal plane I. During the first period of time, the computing device 300 can be in a stereoscopic mode. The image capture device can be configured to capture, during the second period of time after (or before) the first period of time, a second set of images that can be triggered for display when the image capture device 364 is in a position facing towards focal plane J. During the second period of time, the computing device 300 can be a multi-image mode.

In some embodiments, at least one of the image capture devices can be capturing images in a fixed position while the other image capture device is capturing images while moving (e.g., rotating). For example, image capture device 362 can be configured to capture images while in a fixed position, while the image capture device 364 can be configured to capture images while panning (e.g., rotating, moving). In such embodiments, the image capture device 364 can be functioning in, for example, a security mode and/or can be scanning an environment around the computing device 300.

In some embodiments, when the computing device 300 is in the multi-image mode, image capture device 366 can be in an active state and can be directed to a focal plane (not shown) different from focal plane I or focal plane J. In some embodiments, the image capture device 366 can be directed to focal plane I so that a stereoscopic image (or series of images) may be produced using images captured by image capture device 362 and image capture device 366 while the image capture device 364 captures one or more images that are not used to produce one or more stereoscopic image. In some embodiments, the image capture device 364 may be inactive when the image capture device 362 and image capture device 366 are active (e.g., are active and used to produce multiple separate images or stereoscopic images).

In some embodiments, the image capture device 364 may be coupled to a movement mechanism (e.g., a rotate mechanism) different from the movement mechanism 370 shown in FIG. 3. For example, image capture device 364 may be coupled to a mechanism configured to move (e.g., rotate) around one or more axes of rotation (that could each be non-parallel to axis K). In some embodiments, the image capture device 362 and/or the image capture device 366 may be coupled to one or more movement mechanisms. In some embodiments, the image capture device 362 and/or the image capture device 366 may be coupled to one or more movement mechanisms that can be configured to move (e.g., rotate, synchronously move) when movement mechanism 370 moves (e.g., rotates). In such embodiments, the movement mechanism of the image capture device 362 and/or the image capture device 366 may be coupled (e.g., coupled by a pulley) to the movement mechanism 370 of the image capture device 364.

In some embodiments, the image capture devices 362, 364, and/or 366 may be coupled to different portions of the computing device 300 then shown in FIG. 3. For example, the image capture device 364 may be coupled to the display portion 310 below the display 326.

FIG. 4 is a block diagram that illustrates a computing device 400 that includes multiple image capture devices. Specifically, the computing device 400 includes image capture device 10 and image capture device 20. As shown in FIG. 4, the computing device 400 includes an image capture mode controller 410, a capture device management module 420, and an image processor 430. As shown in FIG. 4, the image capture mode controller 410, the capture device management module 420, and the image processor 430 are included in an image engine 405. In some embodiments, one or more portions of the image engine 405 can be associated with (e.g., included in, configured to interface with) one or more applications (such as applications 140 described in connection with FIG. 1D).

As shown in FIG. 4, the computing device 400 includes an image capture mode controller 410 configured to trigger the computing device 400 to operate in one or more image modes. For example, the image capture mode controller 410 can be configured to trigger the computing device 400 to operate in a stereoscopic mode, a multi-image mode, a single-image mode, and/or so forth.

The capture device management module 420 can be configured to manage physical aspects of the image capture devices 10, 20. For example, the capture device management module 420 can be configured to manage focusing of one or more of the image capture devices 10, 20 on one or more objects based on the image mode of the computing device 400. In some embodiments, the capture management module 420 can be configured to trigger movement (e.g., rotation) of one or more of the image capture devices 10, 20 (e.g., trigger rotation into the configuration shown in FIG. 3) based on an image mode of the computing device 400.

The image processor 430 can be configured to process information (e.g., digital information, signaling, compression) from the image capture devices 10, 20, the image capture mode controller 410, and/or the capture device management module 420 to produce one or more images that can be displayed on a display (not shown) of the computing device 400. For example, when the computing device 400 is in the stereoscopic mode the image capture device 10 and the image capture device 20 can each capture images that can be used by the image processor 430 to produce a stereoscopic image.

In some embodiments, one or more portions of the computing device 400 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some embodiments, one or more portions of the image capture mode controller 410, the capture device management module 420 and/or the image processor 430 can be, or can include, a software module configured for execution by at least one processor (not shown). In some embodiments, the functionality of the components can be included in different modules and/or components than those shown in FIG. 4. For example, although not shown, the functionality of the image capture mode controller 410 can be included in a different module than the image capture mode controller 410, or divided into several different modules (not shown).

In some embodiments, the computing device 400 can be included in a network. In some embodiments, the network can include multiple computing devices (such as computing device 400) and/or multiple server devices (not shown). Also, although not shown in FIG. 4, the computing device 400 can be configured to function within various types of network environments. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can be have portions based on various protocols such as Internet Protocol (IP) and/or a proprietary protocol. The network can include at least a portion of the Internet.

As shown in FIG. 4, the computing device 400 can include a memory 440. In some embodiments, the memory 440 can be configured to store information (e.g., an image profile) related to one or more of the image modes of the computing device 400. For example, the memory 440 can be configured to store information related to positions and/or movements of one or more of the image capture devices 10, 20 when the computing device 400 is in one or more of the image modes. As a specific example, the memory 440 can be configured to store information indicating that both the image capture device 10 and the image capture device 20 are to be directed towards (e.g., moved towards, rotated towards) a common focal plane when the computing device 400 is changed to the stereoscopic mode. The memory 440 can also be configured to store information indicating that the image captured devices 10, 20 are to be directed towards (e.g., moved towards, rotated towards) different focal planes when the computing device 400 is changed to the multi-image mode. The memory 440 can also be configured to store information indicating the conditions under which the computing device 400 is to change between image modes. In some embodiments, a condition configured to trigger (e.g., when the condition is satisfied or unsatisfied) the computing device 400 to change between image modes can be referred to as an image condition.

The memory 440 can be any type of memory device such as a random-access memory (RAM) component or a disk drive memory. As shown in FIG. 4, the memory 440 is a local memory included in the computing device 400. Although not shown, in some embodiments, the memory 440 can be implemented as more than one memory component (e.g., more than one RAM component or disk drive memory) within the computing device 400. In some embodiments, the memory 440 can be, or can include, a non-local memory (e.g., a memory not physically included within the computing device 400) within a network (not shown). For example, the memory 440 can be, or can include, a memory shared by multiple computing devices (not shown) within a network. In some embodiments, the memory 440 can be associated with a server device (not shown) on a client side of a network and can be configured to serve several computing devices on the client side of the network.

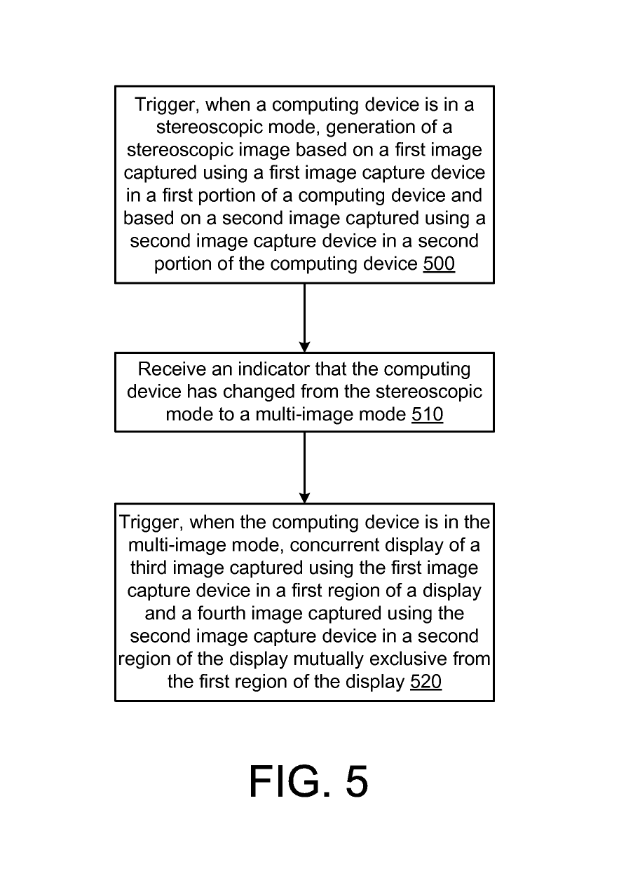

FIG. 5 is a flowchart that illustrates a method for changing image modes of a computing device. In some embodiments, the flowchart can be implemented by, for example, the computing devices shown in FIGS. 1 through 4. Although a specific mode switching sequence is illustrated in FIG. 5, in some embodiments, the mode switching sequence can be different than that illustrated in FIG. 5. For example, the computing device can be configured to change between a single-image mode and the stereoscopic mode.

As shown in FIG. 5, when a computing device is in a stereoscopic mode, generation of a stereoscopic image is trigger based on a first image captured using a first image capture device in a first portion of a computing device and based on a second image captured using a second image capture device in a second portion of the computing device (block 500). In some embodiments, the first image capture device and the second image capture device can be coupled to a display portion of the computing device.

An indicator that the computing device has changed from the stereoscopic mode to a multi-image mode is received (block 510). In some embodiments, the indicator can be produced in response to an interaction of a user with the computing device. In some embodiments, the indicator can be produced in response to one or more of the image capture devices being, for example, moved (e.g., rotated). In some embodiments, the indicator can be produced in response to one or more of the image capture devices failing. Although not shown in FIG. 5, in some embodiments, the computing device can be changed from the multi-image mode to the stereoscopic mode.

When the computing device is in the multi-image mode, concurrent display of a third image captured using the first image capture device in a first region of a display and a fourth image captured using the second image capture device in a second region of the display mutually exclusive from the first region of the display is triggered (block 520). In some embodiments, the third image captured using the first image capture device can be of the object. In some embodiments, the fourth image captured using the second image capture device can be of an object different from the object associated with the first image and the second image. In some embodiments, the computing device can be configured to change from the multi-image mode or the stereoscopic mode to a different mode such as a single image mode. If changed to the single image mode, the first image capture device or the second image capture device can be deactivated (e.g., changed to a deactivated state).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user ca provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments. It should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

1.-22. (canceled)

23. A computer-readable storage medium storing instructions that when executed cause a computing device to perform a process, the process comprising:
processing a stereoscopic image generated based on a first image captured using a first image capture device included in a first portion of the computing device and based on a second image captured at the computing device; and
sending to a remote device via a video conference session and during the processing of the stereoscopic image, at least a portion of a third image captured using at least one of the first image capture device or a second image capture device included in a second portion of the computing device.

24. The computer-readable storage medium of claim 23, wherein the sending is performed while a video conference application associated with the video conference session is operating in a single-image mode concurrent with the processing of the stereoscopic image.

25. The computer-readable storage medium of claim 23, wherein the processing is performed using an application operating in a stereoscopic mode, the sending is performed using a video conference application.

26. The computer-readable storage medium of claim 23, wherein the second image is captured using a third image capture device different from the first image capture device and the second image capture device.

27. The computer-readable storage medium of claim 23, wherein the sending is perform using a video conference application operating in a multi-image mode,
the process further comprising:
receiving an indicator that the computing device has changed from the multi-image mode to a single-image mode.

28. The computer-readable storage medium of claim 23, wherein the sending is performed based on a multi-image mode.

29. The computer-readable storage medium of claim 23, wherein the first image is related to an object distal to a display of the computing device, the second image is related to an object proximal to the display of the computing device.

30. A method, comprising:
establishing a video conference session between a computing device and a remote computing device;
capturing, at the computing device, a first image using a first image capture device included in a first portion of the computing device;
sending the first image to a remote computing device via the video conference session using a video conference application; and
capturing for stereoscopic image processing and during the video conference session, a second image using a second image capture device included in a second portion of the computing device.

31. The method of claim 30, comprising:
capturing for the stereoscopic image processing and during the video conference session, a third image using a third image capture device included in the computing device.

32. The method of claim 30, further comprising:
receiving a plurality of images from the remote computing device via the video conference session; and
simultaneously displaying a first portion of the plurality of images on a first region of a display of the computing device and a second portion of the plurality of images on a second region of the display of the computing device.

33. A computing device, comprising:
a first image capture device included in a first portion of the computing device and configured to capture a first plurality of images;
an image processor configured to process at least a portion of a stereoscopic image based on a first portion of the first plurality of images; and
a second image capture device included in a second portion of the computing device and configured to capture a second plurality of images,
the image processor triggered by a video conference application to send at least a portion of the second plurality of images to a remote computing device via a video conference session.

34. The computing device of claim 33, wherein the video conference application is configured to trigger operation of the computing device in a single-image mode concurrent with the processing of the portion of stereoscopic image performed by the image processor.

35. The computing device of claim 33, further comprising:
a display, the first image capture device is rotatably coupled to the display of the computing device.

36. The computing device of claim 33, further comprising:
a display configured to display a third plurality of images received at the computing device via the video conference session.

37. The computing device of claim 33, wherein the video conference application is configured to change from a single-image mode to a multi-image mode.

38. The computing device of claim 33, wherein the video conference application is configured to trigger operation of the computing device in a single-image mode in response to a feedback signal received from the remote computing device.

39. A computer-readable storage medium storing code representing instructions that when executed are configured to cause a processor to perform a process, the code comprising code to:
trigger, when a computing device is in a stereoscopic mode, generation of a stereoscopic image based on a first image captured using a first image capture device in a first portion of a computing device and based on a second image captured using a second image capture device in a second portion of the computing device;
trigger, when the computing device is in a multi-image mode, concurrent display of at least a portion of a third image captured using the first image capture device in a first region of a display and at least a portion of a fourth image captured using the second image capture device in a second region of the display mutually exclusive from the first region of the display; and
receive an indicator configured to trigger the computing device to change between the stereoscopic mode and the multi-image mode.

40. The computer-readable storage medium of claim 39, wherein the first image capture device is rotatably coupled to a display of the computing device, the indicator is defined in response to the first image capture device being rotated about an axis.

41. The computer-readable storage medium of claim 39, wherein the third image is related to an object distal to a display of the computing device, the fourth image is related to an object proximal to the display of the computing device.

42. The computer-readable storage medium of claim 39, wherein the indicator is defined in response to an interaction of a user with the computing device.

43. The computer-readable storage medium of claim 39, further comprising code to:
receive an indicator that the computing device has changed from the multi-image mode to a single-image mode where the first image capture device or the second image capture device is in an inactive state.

44. The computer-readable storage medium of claim 39, wherein
receive an indicator configured to trigger the computing device to change from the multi-image mode to the stereoscopic mode; and
trigger modification of a field of view the first image capture device or the second image capture device in response to the indicator configured to trigger the computing device to change from the multi-image mode to the stereoscopic mode.
